(19) United States
(12) Patent Application Publication
(10) Pub. No.: US 2024/0242584 A1
(43) Pub. Date: Jul. 18, 2024

(54) MONITORING SYSTEM OF TRACKING AND RECOGNIZING BASED ON THERMAL IMAGES AND MONITORING METHOD THEREOF

(71) Applicant: Digiworks Global Inc., Kaohsiung City (TW)

(72) Inventors: Chin-Feng Chung, Kaohsiung City (TW); Chia-Po Wei, Kaohsiung City (TW); Chung-Hsiang Wang, Kaohsiung City (TW)

(21) Appl. No.: 18/097,381

(22) Filed: Jan. 16, 2023

(51) Int. Cl. G08B 21/04; G06V 10/22; G06V 20/52; G06V 40/20; H04N 7/18; H04N 23/23

(52) U.S. Cl. CPC G08B 21/043; G06V 10/235; G06V 20/52; G06V 40/20; H04N 7/183; H04N 23/23

(57) ABSTRACT

A monitoring method of tracking and recognizing based on thermal images is executed by a monitoring system. The monitoring system includes a monitoring host and a monitoring server. The monitoring host is installed in a ward room, a bathroom, a workplace, or an operation place that needs monitoring. The monitoring host utilizes an infrared camera to capture thermal image frames of care recipients, and utilizes a trained AI human detection model to analyze the thermal image frames for recognizing a motion of a human in the thermal image frames. When the motion matches a condition for generating a warning signal, the monitoring host generates and transmits the warning signal to the monitoring server. Therefore, a care provider can determine whether the care recipients have unexpected behaviors, such as falling from a bed, falling, or staying still for a long time, and can deal with it immediately.

### BACKGROUND OF THE INVENTION

### 1. Field of the Invention

The present invention relates to a monitoring system and a monitoring method, especially a monitoring system and a monitoring method based on infrared thermal images for determining whether care recipients have unexpected behaviors, such as falling out of bed, falling down, or staying still for a long time.

### 2. Description of the Related Art

With the advent of an aging society, demands for technology-assisted care will only increase in the future. The new technology developed must not only meet needs of care institutions, but also be applicable to ordinary families to protect safety of family members.

Caregiving is a quite labor-intensive work. According to public information statistics, a shortfall percentage of long-term care workforce in an aging country is about 20-50%, that is, one care provider needs to undertake a long-term care work of 1.5 manpower at most. The care providers are prone to resign due to overloading of work, such that quality of the long-term care is directly affected, which is a vicious circle. Therefore, if the technology can be used to reduce the workload of the care providers, one care provider may take care of more care recipients, and at the same time safety of the care recipients can be improved.

Conventional image recognition technologies are mostly based on full-color images or black-and-white images captured by general camera units as input data for image recognition. The conventional image recognition technologies include facial recognition, iris recognition, and skeleton-based human action recognition. However, for places that require high degree of privacy, such as hospital wards, long-term care recipients' rooms, and specific toilets, based on legal restrictions and human rights considerations, the aforementioned image recognition technologies have a risk of violating personal privacy because image data can clearly present the appearance of the person being photographed.

Therefore, the image recognition technologies are not suitable to be used for reducing the workload of the long-term care providers, so the long-term care work still requires a lot of manpower to assist in care.

### SUMMARY OF THE INVENTION

In view of the fact that there are accidental accidents where care recipients may fall at a bedside or in a bathroom of a nursing institution or a medical institution, and there is no good technology-assisted solution yet, the main purpose of the present invention is to provide a monitoring system of tracking and recognizing based on thermal images, and a monitoring method thereof. The monitoring system can detect whether care recipients have unexpected behaviors or emergency behaviors, and the monitoring system can automatically send out emergency warnings or rescue signals when necessary.

The monitoring system includes at least one monitoring host and a monitoring server. The at least one monitoring host is installed in an environmental place to monitor personnel statuses in the environmental place. The at least one monitoring host includes a controlling unit, an operating unit, a memory unit, and an I/O unit.

The controlling unit is connected to at least one infrared camera to continuously monitor the environmental place for obtaining a plurality of thermal image frames.

The operating unit is connected to the controlling unit, and receives the thermal image frames from the controlling unit. The operating unit applies a trained artificial intelligence (AI) human detection model to analyze the thermal image frames. The AI human detection model determines whether a human exists in an effective detection area of the thermal image frames, and determines a motion of the human within a monitored area. When the motion of the human matches a condition for generating a warning signal, the AI human detection model generates the warning signal. The warning signal includes dangerous behaviors such as preparing to leave the bed, already leaving the bed, falling down, or sitting or staying still for a long time.

The memory unit is connected to the controlling unit and the operating unit, and stores data and programs.

The I/O unit is connected to the controlling unit and the operating unit, includes at least one transmission interface, and establishes a connection and a data transmission between the monitoring host and external devices.

The monitoring server is communicatively connected to the monitoring host, and includes a cloud device and a local device.

The cloud device is communicatively connected to the monitoring host for receiving the thermal image frames and the warning signal.

The local device is connected to the cloud device, and displays the warning signal.

When the AI human detection model analyzes the thermal image frames, the AI human detection model executes steps of:
(a) determining whether the human is located in the effective detection area of the thermal image frames; if not, disregarding the human;
(b) if yes, assigning an ID to the human located in the effective detection area; wherein when the human assigned with the ID leaves the effective detection area, the ID of the human is removed;
(c) recognizing the motion of the human, and adding one to a counter value of the motion; when the counter value of the motion of the human exceeds a threshold value, the operating unit generates the warning signal.

In the present invention, the AI human detection model is built by a deep learning method, and may be a neural network model. The trained AI human detection model can track multiple humans and recognize motions of the humans within the thermal image frames. When the motion of the human of a care recipients matches a preset rule of generating the warning signal, the AI human detection model can automatically generate the warning signal such that a care provider can confirm safety of the care recipients.

The motion that can be detected by the AI human detection model of the present invention may include dangerous motions and behaviors that often cause safety incidents. For example, the motion that can be detected by the AI human detection model may include but are not limited to: getting up on the bed and preparing to leave the bed, already leaving the bed, falling by the bed, sitting on the toilet for a long time, falling in the bathroom, and staying still in specific offices or workplaces, etc.

Moreover, the present invention recognizes the motion of the human based on infrared thermal image data. The infrared thermal image data do not clearly show human faces or detailed movements of human limbs, such that the personal privacy of the care recipients can be improved. Therefore, the present invention can provide security care and monitoring of the care recipients, and can also protect human rights.

### BRIEF DESCRIPTION OF THE DRAWINGS

FIG. 1 is a flowchart of building an AI human detection model of the present invention;

FIG. 2 is a block diagram of a monitoring system of tracking and recognizing based on thermal images of the present invention;

FIG. 3A is a schematic diagram of the present invention applied to a single-person monitoring mode;

FIG. 3B is a schematic diagram of the present invention applied to a multi-person monitoring mode;

FIG. 4 is a flowchart of a monitoring method of tracking and recognizing based on thermal images of the present invention;

FIGS. 5A to 5D are schematic diagrams of thermal images in the single-person monitoring mode;

FIGS. 6A to 6D are schematic diagrams of thermal images in the multi-person monitoring mode;

FIG. 7 is another flowchart of the monitoring method of tracking and recognizing based on thermal images of the present invention

FIGS. 8A to 8D are schematic diagrams of thermal images for monitoring a bathroom with a toilet.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

The present invention builds an AI human detection model according to a deep learning method, and the AI human detection model can detect a human and recognize a motion of the human in real time. An advantage of the AI human detection model is that the AI human detection model can immediately recognize a “real-time state” of the human in each thermal image frame. For example, the real-time state of the human may be sitting on a bed. At this time, there are two possibilities. One possibility is that the human gets ready to stand up and leave the bed. Another possibility is that the human just remains sitting on the bed. The AI human detection model can detect the real-time states of the thermal image frames to recognize the motion of the human, and the AI human detection model can quickly and effectively generate a warning signal when necessary.

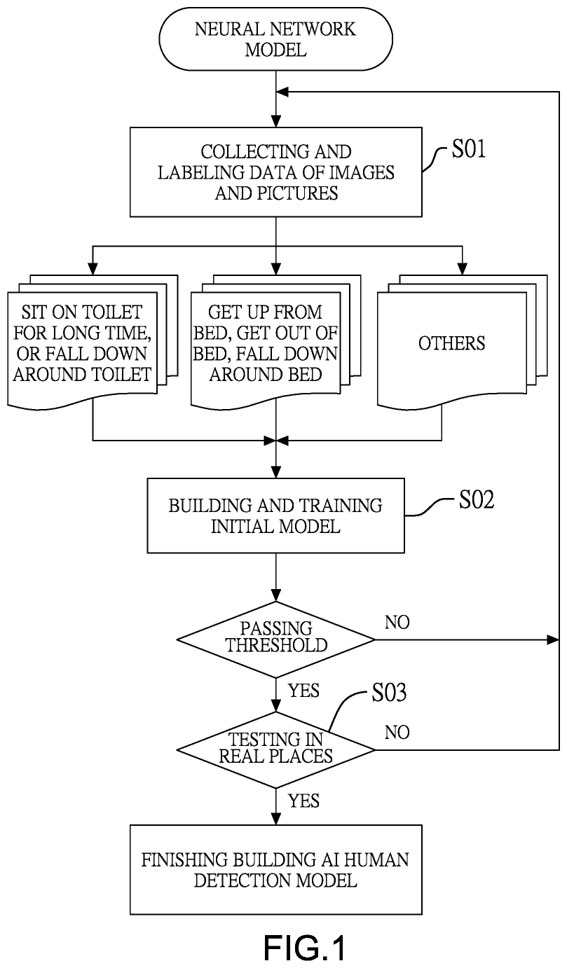

With reference to FIG. 1, FIG. 1 is a flowchart of building the AI human detection model of the present invention, and includes the following steps:

Step 01: collecting and labeling data of images and pictures;

In the step 01, the present invention collects the data from thermal image frames captured by at least one infrared camera. The data include image frames specially demonstrated by a human, image frames of a video/picture of care recipients in actual places, such as medical institutions and long-term care institutions, or image frames of a video/picture of persons who need to be monitored in a specific office or workplace. The data can include continuous image frames or discontinuous image frames. The infrared camera can capture thermal image frames of multiple different parties, including 24 hours in a row or at different time intervals. As far as possible, the thermal image frames take maximization and diversity of the care receivers, time range, or motions as a sampling benchmark. Therefore, the thermal image frames can include various motions. The thermal image frames are classified according to the different humans, and assigned by designated labels to different motions. For example, labeling items may include, but are not limited to, “sit on a toilet for a long time, or fall down around the toilet”, “get up from a bed, get out of the bed, fall down around the bed”, and “others”, etc. The labeling item of “other” mainly refers to the care recipient in a wheelchair, the care recipient using walking aids, the care recipient being hunchbacked, a care provider cleaning, the care provider assistance in bathing, etc.

Step 02: building and training an initial model of the AI human detection model;

In the step 02, when the thermal image frames of the motions are labeled, about 700 frames are extracted according to the labels of each motion. 90% of the extracted frames of each motion are used for training the AI human detection model, and 10% of the extracted frames of each motion are used for testing or validating the AI human detection model. When the AI human detection model is tested, the AI human detection model is tested with the same motions 10 times. When the AI human detection model correctly labels 9 times (inclusive) or more, an accuracy rate of the AI human detection model reaches a threshold, and the AI human detection model passes the test. Therefore, the initial model of the AI human detection model is built. Moreover, image data of key behaviors of transition states or other items between different motions are further collected and labeled for training the initial model. In the embodiment, the AI human detection model may be a neural network model, and the neural network can be trained by a machine learning method such as an Object detection method, for example, a Faster R-CNN, YOLO, or a RetinaNet. The object detection method uses a convolutional neural network (CNN) to extract image features. For example, an input layer of a YOLOv3 receives 640×480 thermal images, hidden layers of the YOLOv3 adapt to a Darknet-53 containing 53 convolutional layers, and an output layer of the YOLOv3 predicts 7 motion categories. During a training process, Binary Cross Entropy is used as a loss function for classification, and a Mean Squared Error is used as a loss function of a predicted bounding box. Training data contain about 5,000 labeled thermal image frames, and a preprocessing includes Gaussian blur, horizontal flip, and rotation less than 15 degrees. According to experimental results, when a Tiny YOLOv3 (lite version of YOLOv3) is used as the AI human detection model, the AI human detection model can successfully recognize 7 different types of motions, and a Mean Average Precision (MAP) can reach 95%. A detection speed on Raspberry Pi 4^{th} generation can reach 3˜4 frames per second (FPS). The present invention contributes to realization of auxiliary care and monitoring according to the thermal image frames and application of human motion detection.

Step 03: testing the AI human detection model in real places.

In order to obtain the AI human detection model having a high prediction accuracy, the present invention can set up the AI human detection model that has passed the test in a target place for demonstrating and final testing. In multiple different places, for example 3˜5 places, multiple sets of equipment, for example 5˜10 sets, are mounted in each place to demonstrate and final test. Each response of each set of the equipment is observed over a period of time, and the sets of the equipment can be immediately adjusted. For example, an installation angle of a hardware, visual area range, and software setting parameters of the set of the equipment can be immediately adjusted according to the response of the set of the equipment. If there is an abnormality, abnormal data can be used to retrain the AI human detection model, and to test and verify collections and labels of the thermal image frames of the key motions. Therefore, the AI human detection model can be optimized with retraining data, and an available AI human detection model can be finally obtained.

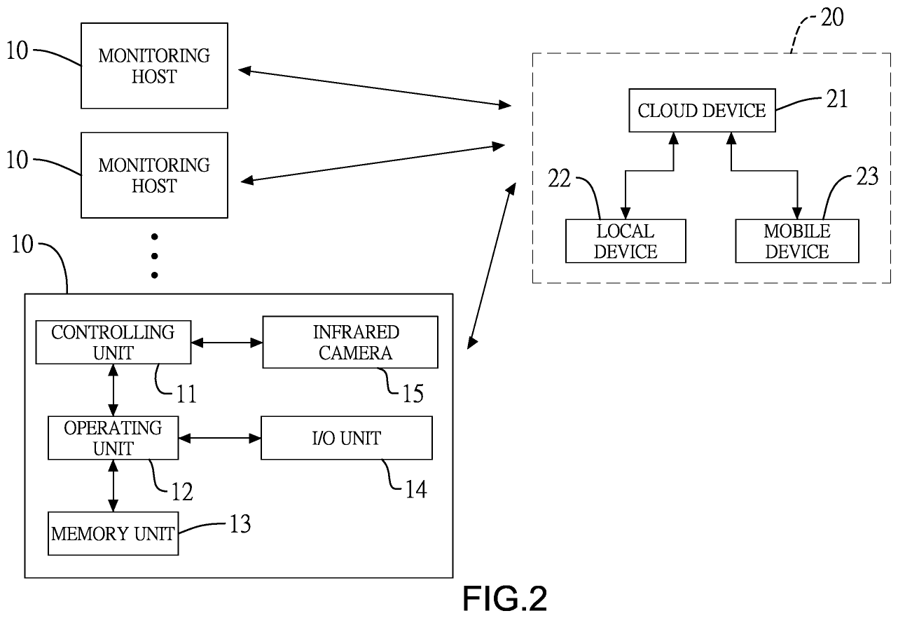

With reference to FIG. 2, FIG. 2 is a block diagram of a monitoring system of tracking and recognizing based on thermal images of the present invention. The monitoring system includes at least one MONITORING HOST 10 and a monitoring server 20. When there are multiple monitoring hosts 10, the multiple monitoring hosts 10 are respectively mounted in different preset places. For example, the monitoring hosts 10 can be mounted in a ward room to monitor the human on a bed, or can be mounted in a bathroom to monitor the human near a toilet. The monitoring hosts 10 are communicatively connected to the monitoring server 20, and transmits recognition result to the monitoring server 20.

Each monitoring host 10 includes a controlling unit 11, an operating unit 12, a memory unit 13, and an I/O unit 14. The controlling unit 11 may be a control circuit board that is built based on a Raspberry Pi, or Arduino kit, or the control circuit board is a printed circuit board assembly (PCBA) of a mass production version. The controlling unit 11 can be connected to an infrared camera 15, a sensor, an expansion board, or other elements. The infrared camera 15 captures thermal image frames from the place mounted with the monitoring host 10.

The operating unit 12 is connected to the controlling unit 11. The operating unit 12 includes microprocessors, such as a central processing unit (CPU), and a Graphics Processing Unit, or the operating unit 12 may be an operation acceleration external unit, such as an Intel® Movidius™ Neural Compute Stick 2. The operating unit 12 receives the thermal image frames captured by the infrared camera 15 through the controlling unit 11. The operating unit 12 further executes data calculation, database operation, and the AI human detection model for recognizing the thermal image frames.

The memory unit 13 is connected to the controlling unit 11 and the operating unit 12. The memory unit 13 includes a built-in memory on the control circuit board of the controlling unit 11 or an external expansion memory card, and the memory unit 13 stores an operating system, programs, and data.

The I/O unit 14 is connected to the controlling unit 11 and the operating unit 12. The I/O unit 14 includes at least one I/O interface, or multiple I/O interfaces of different specifications. The I/O interfaces may include HDMI interface, USB interface, wire network transmission interface, wireless network transmission interface, or other standard connectors, etc. The I/O unit 14 is connected to the monitoring host 10 and other external devices to transmit data. For example, the monitoring host 10 can be wiredly or wirelessly connected to the monitoring server 20 through the I/O unit 14.

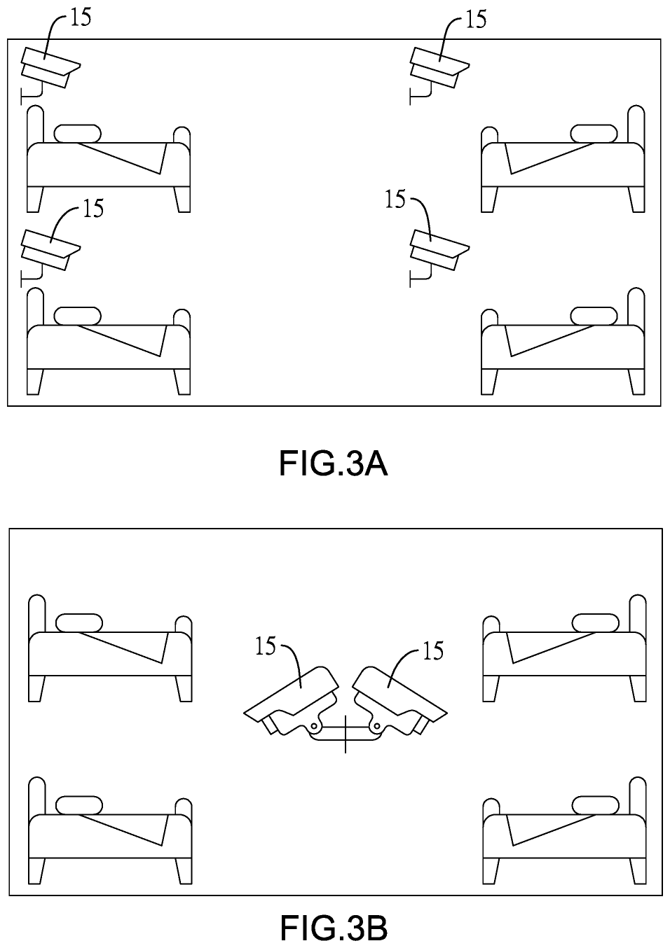

When the monitoring host 10 is mounted in a specific place, such as the ward room, the infrared camera 15 can be mounted on a headboard of the bed, on a footboard of the bed, in an aisle, or on a ceiling on an opposite wall. An angle between a viewing angle of the infrared camera 15 and a horizontal line may be 15 to 60 degrees, and the viewing angle of the infrared camera 15 is set to be better for conveniently monitoring motions of care recipients, or staying places of the care recipients. An effective detection area monitored by the monitor host 10 includes a setting range of a full or partial bed, or an area of walkways around the bed. With reference to FIG. 3A, each infrared camera 15 can monitor one bed to execute a single-person monitoring mode. With reference to FIG. 3B, each infrared camera 15 can be mounted on a walkway between headboards of two beds or footboards of the two beds to monitor the two beds for executing a multiple-person monitoring mode. In the multiple-person monitoring mode, the infrared camera 15 can simultaneously monitor the effective detection area including the walkway between two beds and the two beds.

When the monitoring host 10 is mounted in the bathroom, the infrared camera 15 can be mounted on the ceiling above, in front of, or on left/right side of the toilet. The infrared camera 15 is set to be better for conveniently monitoring motions of care recipients, or staying places of the care recipients. The effective detection area monitored by the monitor host 10 includes a standing range around the toilet, sitting range around the toilet, or walkways around the toilet when the toilet is in use.

The monitoring server 20 includes a cloud device 21, a local device 22, or a mobile device 23. The cloud device 21 is connected to the monitoring hosts 10, and receives thermal image frames and warning signals from the monitoring hosts 10. The local device 22 is mounted in a fixed place. For example, the fixed place may be a nursing station. The local device 22 can further be connected to the cloud device 21, and displays the waning signal. The mobile device 23 can be carried by a nurse or the care provider, and is installed with an application program. The mobile device 23 can be connected to the cloud device 21 and display thermal image frames captured by the infrared camera 15 through the application program. Further, the mobile device 23 can display the warning signal though the application program.

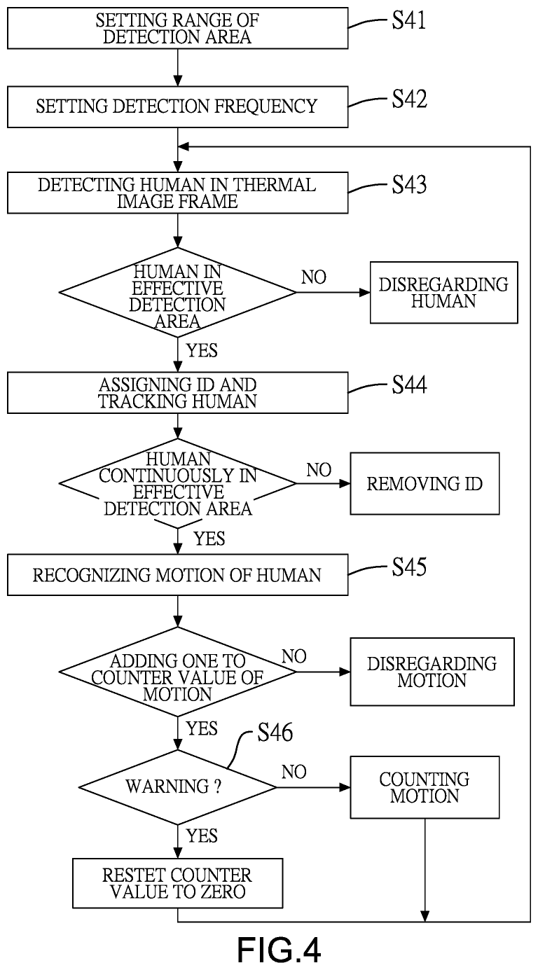

With reference to FIG. 4, FIG. 4 is a flowchart of a monitoring method of tracking and recognizing based on the thermal images of the present invention. In the embodiment, a situation in which a movement in the ward is prone to danger is taken as an example. The monitoring method includes steps of:

Step S41: setting a range of a detection area;

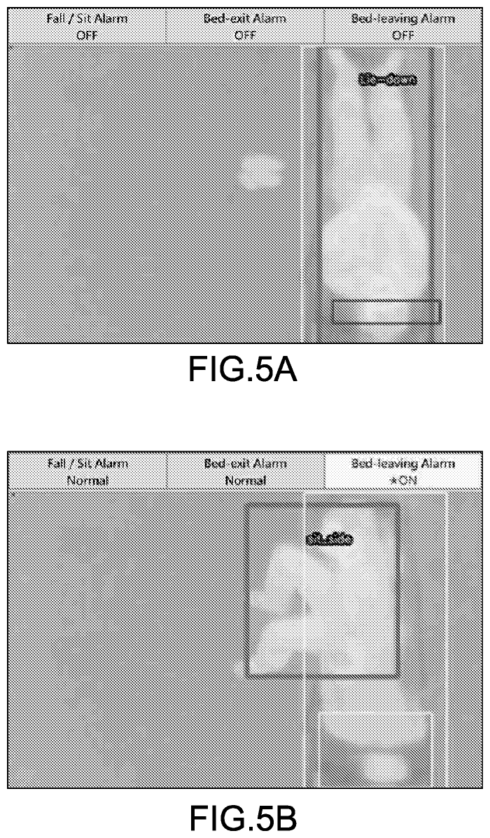

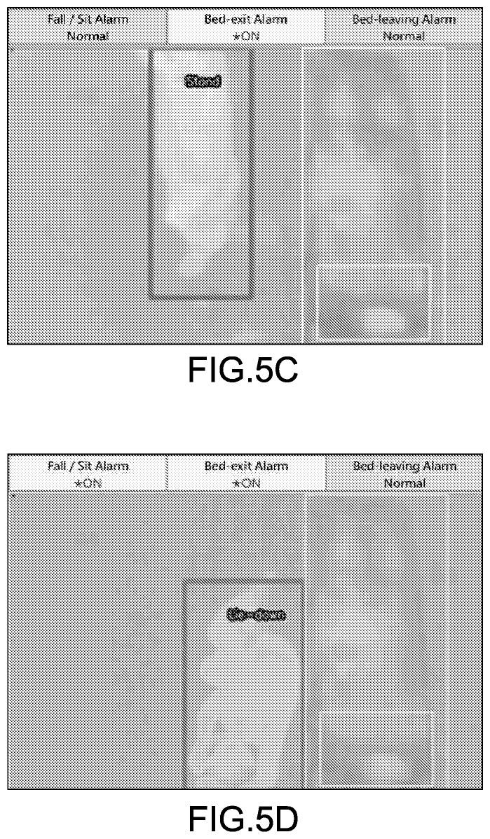

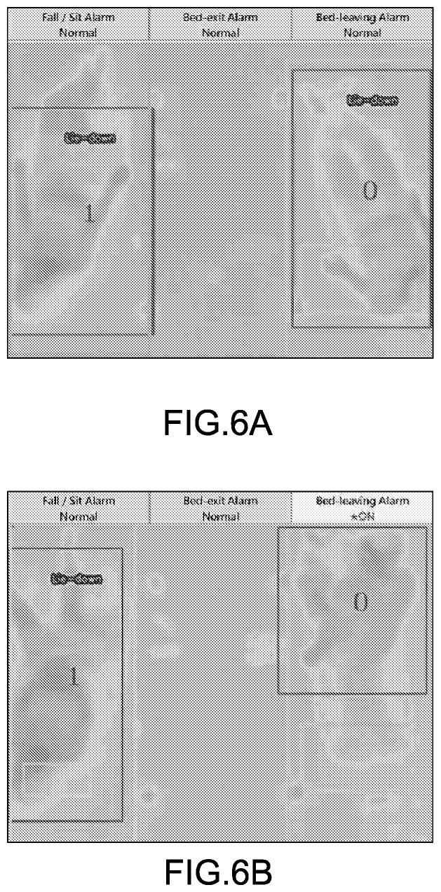

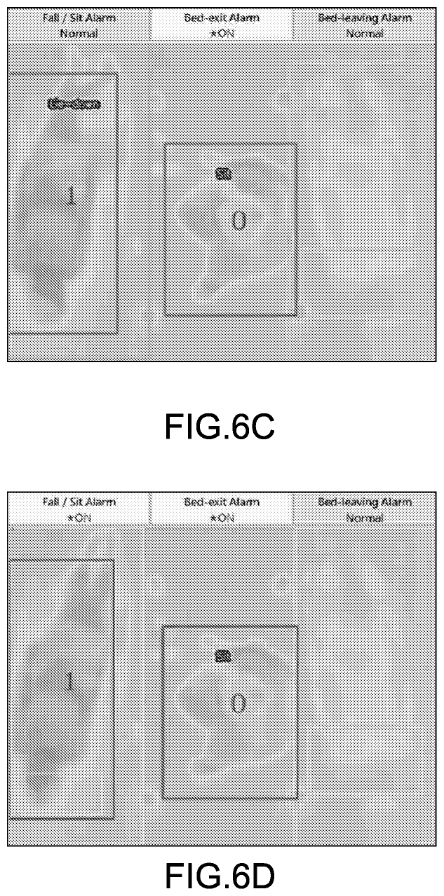

In step S41, for example, 100% of an overall image frame captured by the infrared camera 15 is a visible area. A user can input a command to set “an effective detection area” and one or more “monitored areas”. The monitored area may be an area of the bed. For example, in the ward room, a length rage of 0% to 80% from a left side of the visible area can be selected as “the effective detection area”, and a length rage of 10% to 40% from the left side of the visible area can be selected as “the area of the bed”. The monitored area, such as the area of the bed, can be fully or partially located in the effective detection area. With reference to FIGS. 5A to 5D and FIGS. 6A to 6D, white rectangular frames displayed in the thermal image frames shown in FIGS. 5A to 5D may be the area of the bed. The white rectangular frames displayed on the left side and right side of the thermal image frames shown in FIGS. 6A to 6D may also be the area of the bed.

Step S42: setting a detection frequency;

In step S42, the user can set a number of thermal image frames needed to be processed per unit time. For example, the infrared camera 15 can be set to capture a real-time image frame according to a frequency of 1 to 12 frames per second (FPS). Besides, a capture rate of the infrared camera 15 can also be set according to a fixed frequency, such as 3 FPS. The fully built AI human detection model can execute the following step S43 to step S46 for each of the thermal image frames captured by the infrared camera 15.

Step S43: detecting a human in the thermal image frame;

In step S43, if the AI human detection model detects one or more humans, the AI human detection model further determines whether the one or more humans in the thermal image frame is/are located in “the effective detection area” of the thermal image frame. If yes, step S44 is executed. If not, the one or more humans not located in “the effective detection area” is/are disregarded. With reference to FIGS. 5A to 5D, in the single-person monitoring mode, black rectangular frames represent that one human is detected. With reference to FIGS. 6A to 6D, in the multiple-person monitoring mode, multiple black rectangular frames represent that multiple humans are detected in the thermal image frame.

Step S44: assigning an identification (ID) to the human located in the effective detection area, and tracking the human;

In step S44, each detected human is assigned with a unique ID, such as numbers of 0, 1, 2, etc. When the humans are detected, the AI human detection model tracks the humans. If there is a new human entering “the effective detection area”, the newly entering human is assigned with a new ID. When any one of the detected humans generates the motion, step S45 is executed. If one of the detected humans leaves “the effective detection area”, the ID of the detected human who left is removed. With reference to FIGS. 6A to 6D, the multiple detected humans are respectively assigned with the IDs of “O” and “1”.

Step S45: recognizing a motion of the human;

In step S45, the fully built AI human detection model recognizes the motions of the human of the thermal image frames. The AI human detection model compares each of the motions of the human of the thermal image frames with trained motions to determine a most similar motion from the trained motions, and the AI human detection model counts numbers of each of the trained motions. For example, if there are 2 motions of the human similar to the trained motion of a lie-down motion, the number of the trained motion of the lie-down motion is counted to be 2. If the AI human detection model determines that the motion of the human is not similar to any one of the trained motions, the AI human detection model disregards the motion of the human, and does not count the number of the disregarded motion. With reference to FIGS. 5A to 5D, for example, if a monitoring environment is the ward room, the AI human detection model can compare the motions of the human with the trained motions, such as “lie-down” (lying on the bed), “sit” (preparing to leave the bed), “stand” (already leaving the bed), and “fall-down”. With reference to FIGS. 6A to 6D, motions of the human on a left side of the thermal image frames maintains “lie-down”. Motions of the human on a right side of the thermal image frames respectively are “lie-down” in FIG. 6A, “sit” in FIG. 6B, “stand” in FIG. 6C, and “fall-down” in FIG. 6D.

Step S46: generating the warning signal;

In step S46, when the motions of the care recipients in the ward room are recognized to be “sit”, “stand”, or “fall-down”, and any one of the numbers of the trained motions reaches a threshold, the AI human detection model generates the warning signal. Moreover, different trained motions can set different thresholds. For example, a threshold of “sit” can be set greater than thresholds of the other trained motions, and thresholds of “stand” or “fall-down” can be set smaller than thresholds of the other trained motions.

For example, when the care recipient gets up from the bed, the AI human detection model recognizes that the motions of the human in the thermal image frames are “lie-down” to “sit”. In one embodiment, the detection frequency is set to be 3 FPS in step S42, and the threshold of “sit” is 15. When the AI human detection model recognizes the motions of the human in the thermal image frames to be “sit”, and the motions of the human maintain for 5 seconds, the AI human detection model counts the number of “sit” to be more than 15, which is the threshold of “sit”. Therefore, the AI human detection model generates the warning signal, transmits the warning signal to the monitoring server 20, resets the number of “sit” to be 0, and continuously recognizes a next thermal image frame. For example, in FIG. 5B, when the AI human detection model recognizes the motion of the human is “sit_side”, and counts the number of “sit side” to be more than a threshold of “sit_side”, the AI human detection model will generate the warning signal of “bed-leaving alarm”. In FIG. 5C, after a series of motions, the human already left the bed. Namely, the human is out of the area of the bed, the AI human detection model recognizes the motion of the human is “stand”, and counts the number of “stand” to be more than a threshold of “stand”. At this time, the AI human detection model will generate the warning signal of “bed-exit alarm”. In FIG. 5D, when the human is out of the area of the bed but still in the effective detection area, and the AI human detection model recognizes the motion of the human is “lie-down”, and counts the number of “lie-down” to be more than a threshold of “lie-down”, the AI human detection model will generate the warning signal of both “fall/sit alarm” and “bed-exit alarm”. Similarly, the AI human detection model respectively recognizes the motions of the human on the right sides of the thermal image frames of FIGS. 6B, 6C, and 6D, and respectively generates the warning signals of “bed-leaving alarm”, “bed-exit alarm”, and both “fall/sit alarm” and “bed-exit alarm”.

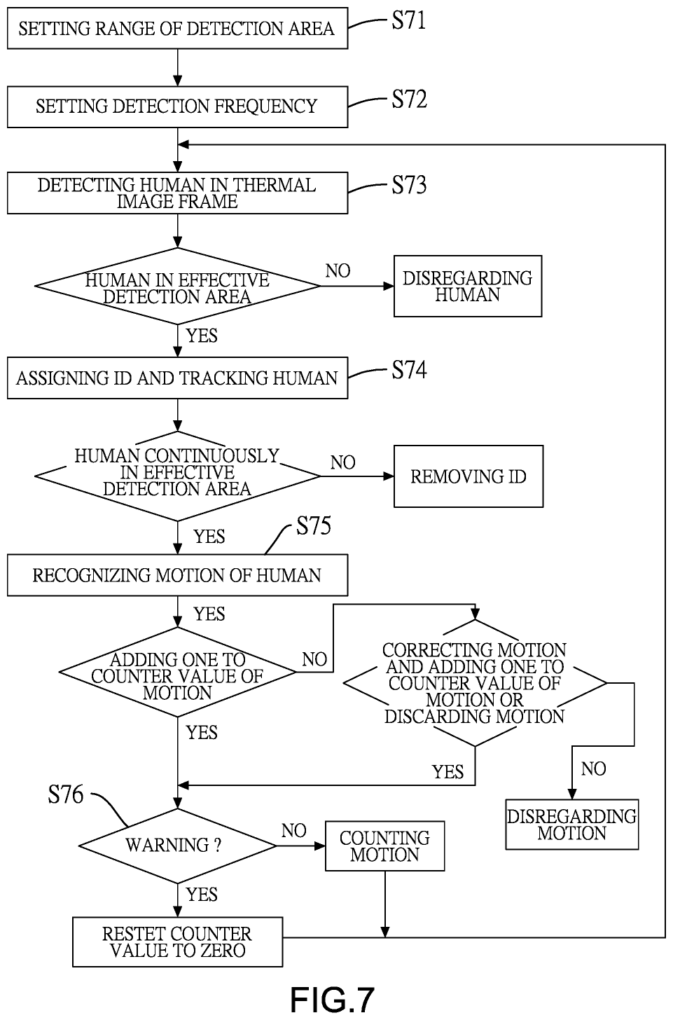

With reference to FIG. 7, FIG. 7 is another flowchart of the monitoring method of tracking and recognizing based on the thermal images of the present invention. In the embodiment, a situation that is prone to danger when staying still for a long time is taken as an example. The monitoring method includes steps of:

Step S71: setting a range of a detection area;

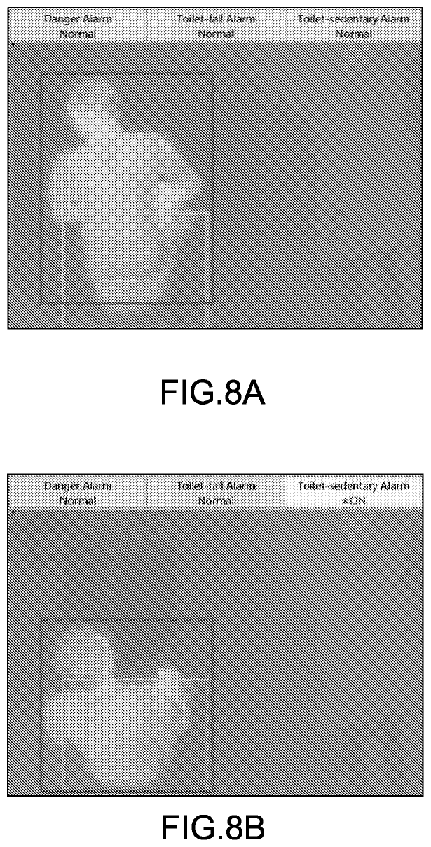

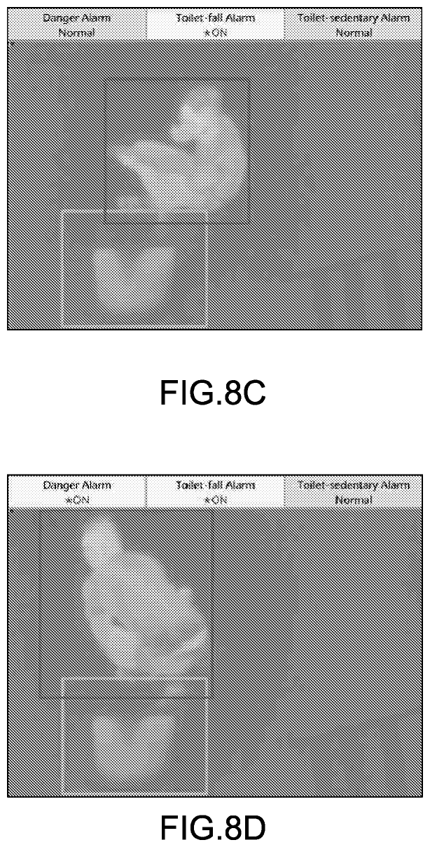

In step S71, for example, 100% of the overall image frame captured by the infrared camera 15 is the visible area. The user can set “the effective detection area” and one or more “monitored areas”. For example, in the bathroom, the length rage of 0% to 100% from the left side of the visible area can be selected as “the effective detection area”. The monitored area may be an area of the toilet, an area of a workplace, or an area of an operation place. The area of the toilet can be selected by an appropriate area including the toilet and around the toilet. The area of the toilet can be fully or partially located in the effective detection area. With reference to FIGS. 8A to 8D, white rectangular frames displayed in the thermal image frames shown in FIGS. 8A to 8D may be the area of the toilet.

Step S72: setting a detection frequency;

In step S72, the user can set the number of thermal image frames needed to be processed per unit time. For example, the infrared camera 15 can be set to capture the real-time image frame according to the frequency of 1 to 12 FPS. Besides, the capture rate of the infrared camera 15 can also be set according to a fixed frequency, such as 3 FPS. The fully built AI human detection model can execute the following step S73 to step S76 for each of the thermal image frames captured by the infrared camera 15.

Step S73: detecting a human in the thermal image frame;

In step S73, if the AI human detection model detects one or more humans, the AI human detection model further determines whether the one or more humans in the thermal image frame is/are located in “the effective detection area” of the thermal image frame. If yes, step S74 is executed. If not, the one or more humans not located in “the effective detection area” is/are disregarded. With reference to FIGS. 8A to 8D, black rectangular frames represent that the human is detected.

Step S74: assigning the ID to the human located in the effective detection area, and tracking the human;

In step S74, each detected human is assigned with the unique ID, such as numbers of 0, 1, 2, etc. When the humans are detected, the AI human detection model tracks the humans. If there is a new human entering “the effective detection area”, the newly entering human is assigned with a new ID. When any one of the detected humans generates the motion, step S75 is executed. If one of the detected humans leaves “the effective detection area”, the ID of the detected human who left is removed.

Step S75: recognizing a motion of the human;

In step S75, the fully built AI human detection model recognizes the motions of the human of the thermal image frames. The AI human detection model compares each of the motions of the human of the thermal image frames with trained motions to determine a most similar motion from the trained motions, and the AI human detection model counts numbers of each of the trained motions. For example, if there are 2 motions of the human similar to the trained motion of a lie-down motion, the number of the trained motion of the lie-down motion is counted to be 2. If the thermal image frames are blurry or the motions of the human are not easily recognized, the AI human detection model determines the motions of the human according to previous 3 to 10 thermal image frames. The AI human detection model corrects the motions not easily recognized according to continuous motions with more motion records, heavier weight, or higher possibility, and the AI human detection model compares the corrected motions with the trained motion to determine the most similar motion from the trained motions. The AI human detection model counts the number of each of the trained motions. Therefore, the motions not easily recognized can be corrected to ensure that the motions of the human, such as the care recipient, can be correctly and immediately alerted. If the AI human detection model determines that the motion of the human is not similar to any one of the trained motions, the AI human detection model disregards the motion of the human, and does not count the number of the disregarded motion. With reference to FIGS. 8A to 8D, for example, if the monitoring environment is the bathroom, the AI human detection model can compare the motions of the human with the trained motions, such as “sedentary”, and “fall”.

Step S76: generating the warning signal;

In step S76, when the motions of the care recipients in the ward room are recognized to be “sedentary”, “fall”, or “danger”, and any one of the numbers of the trained motions reaches the threshold, the AI human detection model generates the warning signal. Moreover, different trained motions can set different thresholds. For example, a threshold of “sedentary” can be set greater than thresholds of the other trained motions, and thresholds of “fall”, or “danger” can be set smaller than thresholds of the other trained motions.

FIGS. 8A to 8D show an example that the present invention is used for monitoring the bathroom according to the thermal image frames, and the present invention can also be used for monitored areas where dangerous incidents often occur if the human remains still for a long time. For example, FIG. 8A shows that the human, such as the care recipient, sits on the toilet. FIG. 8B shows that the human sits on the toilet for a long time, and “the toilet-sedentary alarm” is triggered. FIG. 8C shows that the human falls down in the monitored area around the toilet, and “the toilet-fall alarm” is triggered. FIG. 8D shows that the human has fallen down for a long time, and “the danger alarm” and “the toilet-fall alarm” are triggered. The foregoing examples show that different behaviors and different risk levels of the behavior to generate the warning signals in real time to timely ensure the life safety of the care recipient. When determining whether it is necessary to generate the warning signals for “the toilet-sedentary alarm”, “the toilet-fall alarm”, or “the danger alarm”, the principles are similar to generate the warning signals of monitoring the ward room. Examples are as follows:

### The Toilet-Sedentary Alarm:

In FIG. 8B, when the care recipient has sat on the toilet for a first preset time period, for example, 1 to 10 minutes, “the toilet-sedentary alarm” is triggered. When the care recipient has sat on the toilet for a second preset time period, for example, 20 minutes, “the danger alarm” is triggered.

### The Toilet-Fall Alarm:

In FIG. 8C, when the care recipient has sat down or fallen down out of the area of the toilet but in the effective detection area for a third preset time period, for example, 1 to 5 seconds, “the toilet-fall alarm” is triggered.

### The Danger Alarm:

In FIG. 8D, when the care recipient has sat down or fallen down out of the area of the toilet but in the effective detection area for a fourth preset time period, for example, 1 to 300 seconds, “the danger alarm” is triggered. The above mentioned “the toilet-sedentary alarm” can also be used to a specific office or workplace for monitoring and warning prolonged immobility behaviors. Namely, the warning signal can be “a remain-still alarm”, including dangerous behaviors of sitting for a long time, or lying on the ground. When “the remain-still alarm” has been triggered for a fifth preset time period, for example, seconds, “the danger alarm” is triggered.

In conclusion, in order to detect the abnormal and emergency behaviors of the care recipients, the present invention uses the thermal image frames taken by the infrared camera 15 as the data source, and the present invention at least has the following advantages:
1. The present invention uses the AI human detection model to track and detect multiple persons at the same time, and the AI human detection model can determine the dangerous behavior through comparisons of program rules. When the conditions are met, the AI human detection model sends an emergency alarm to ensure the safety of the care recipients. The behaviors that can be detected by the present invention include, but are not limited to, dangerous behaviors that often cause safety incidents, such as getting up on the bed and preparing to leave the bed, already leaving the bed, falling near the bed, sitting on the toilet for a long time, falling near the toilet, or staying still for a long time.
2. The details of the face and body movements are blurred and difficult to identify, so there is no concern about violating personal privacy. However, the use of traditional cameras can clearly capture human faces, which need to be erased after post-processing, and it is impossible to guarantee 100% free from risk of personal data leakage.
3. The human body has a stable heat source that can be detected by the infrared camera 15 and can be separated from the surrounding environment, so the human can still be clearly recognized even if the surrounding environment is dimly lit. However, the traditional camera cannot obtain clear image frames under dim light sources, so the image frames obtained by the traditional camera is difficult to be identified. At the same time, the present invention can also determine whether a body temperature of the care recipient is too high to cause health hazards according to the thermal image frames.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A monitoring system of tracking and recognizing based on thermal images, comprising:
at least one monitoring host, installed in an environmental place to monitor personnel statuses in the environmental place; wherein the at least one monitoring host includes:
a controlling unit, connected to at least one infrared camera to continuously monitor the environmental place for obtaining a plurality of thermal image frames;
an operating unit, connected to the controlling unit, and receiving the thermal image frames from the controlling unit; wherein the operating unit applies a trained artificial intelligence (AI) human detection model to analyze the thermal image frames; wherein the AI human detection model determines whether a human exists in an effective detection area of the thermal image frames, and determines a motion of the human within a monitored area; wherein when the motion of the human matches a condition for generating a warning signal, the AI human detection model generates the warning signal; wherein the warning signal comprises at least one of static behaviors or dangerous behaviors of preparing to leave the bed, already leaving the bed, falling down, or sitting for a long time;
a memory unit, connected to the controlling unit and the operating unit, and storing data and programs; and
an I/O unit, connected to the controlling unit and the operating unit, comprising at least one transmission interface, and establishing a connection and a data transmission between the at least one monitoring host and external devices;
a monitoring server, communicatively connected to the at least one monitoring host, and comprising:
a cloud device, communicatively connected to the at least one monitoring host for receiving the thermal image frames and the warning signal;
a local device, connected to the cloud device, and displaying the warning signal;
wherein when the AI human detection model analyzes the thermal image frames, the AI human detection model executes steps of:
(a) determining whether the human is located in the effective detection area of the thermal image frames; if not, disregarding the human;
(b) if yes, assigning an ID to the human located in the effective detection area; wherein when the human assigned with the ID leaves the effective detection area, the ID of the human is removed;
(c) recognizing the motion of the human, and adding one to a counter value of the motion; wherein when the counter value of the motion of the human exceeds a threshold value, the operating unit generates the warning signal.

2. The monitoring system as claimed in claim 1, wherein the monitoring server further comprises a mobile device;
wherein the mobile device is installed with an application program, and is connected to the cloud device for receiving the warning signal through the application program.

3. The monitoring system as claimed in claim 1, wherein the monitored area comprises an area of the bed, an area of a toilet, an area of a workplace, or an area of an operation place;
wherein the monitored area is fully or partially located in the effective detection area.

4. The monitoring system as claimed in claim 3, wherein the monitored area and the effective detection area are set according to a command inputted by a user.

5. The monitoring system as claimed in claim 1, wherein when the AI human detection model recognizes the motion of the human, the AI human detection model recognizes the motion of the human according to a previous first preset number of the thermal image frames by recognizing the motion having the largest number of motion records, the motion having the heaviest weight, or the motion having the highest possibility, and the AI human detection model adds one to the counter value of the motion.

6. A monitoring method of tracking and recognizing based on thermal images, executed by an operating unit of at least one monitoring host, and comprising step of:
receiving thermal image frames captured by an infrared camera;
applying a trained artificial intelligence (AI) human detection model to analyze the thermal image frames; wherein when the AI human detection model analyzes the thermal image frames, the AI human detection model executes steps of:
(a) determining whether a human is located in an effective detection area of the thermal image frames; if not, disregarding the human;
(b) if yes, assigning an ID to the human located in the effective detection area; wherein when the human assigned with the ID leaves the effective detection area, the ID of the human is removed; and
(c) recognizing a motion of the human, and adding one to a counter value of the motion; wherein when the counter value of the motion of the human exceeds a threshold value, the operating unit generates a warning signal.

7. The monitoring method as claimed in claim 6, wherein before receiving the thermal image frames, the monitoring method further comprises steps of:
setting a range of a detection area; wherein an overall image frame captured by the infrared camera is a visible area, and the effective detection area and one or more monitored areas are set according to a command inputted by a user; and
setting a detection frequency; wherein a number of the thermal image frames needed to be processed by the AI human detection model per unit time is set.

8. The monitoring method as claimed in claim 6, wherein the monitored area comprises an area of the bed, an area of a toilet, an area of a workplace, or an area of an operation place; and
wherein the monitored area is fully or partially located in the effective detection area.

9. The monitoring method as claimed in claim 6, wherein the warning signal comprises at least one of static behaviors or dangerous behaviors of preparing to leave the bed, already leaving the bed, falling down, or sitting or staying still for a long time;

10. The monitoring method as claimed in claim 6, wherein when the AI human detection model recognizes the motion of the human, the AI human detection model recognizes the motion of the human according to a previous first preset number of the thermal image frames by recognizing the motion having the largest number of motion records, the motion having the heaviest weight, or the motion having the highest possibility, and the AI human detection model adds one to the counter value of the motion.
